(19) United States
(12) Patent Application Publication
(10) Pub. No.: US 2025/0095940 A1
(43) Pub. Date: Mar. 20, 2025

(54) RELAY

(71) Applicant: Xiamen Hongfa Electric Power Controls Co., Ltd., Xiamen (CN)

(72) Inventors: Wenguang Dai, Xiamen (CN); Dapeng Fu, Xiamen (CN); Yiwen Wu, Xiamen (CN); Liji Su, Xiamen (CN)

(21) Appl. No.: 18/884,727

(22) Filed: Sep. 13, 2024

(30) Foreign Application Priority Data
Sep. 14, 2023 (CN) 2023111877478

(51) Int. Cl. H01H 50/54; H01H 50/18

(52) U.S. Cl. CPC H01H 50/541; H01H 50/18

(57) ABSTRACT

A relay includes a movable contact assembly comprising a movable contact piece; a push rod assembly configured to push the movable contact assembly to move, to make the movable contact piece contact with or separate from a static contact leading-out terminal; a limiting component connected to the movable contact assembly and the push rod assembly, and configured to restrict the movable contact assembly from rotating around an axis of the push rod assembly relative to the push rod assembly; and an elastic assembly configured to provide a contact pressure.

### CROSS REFERENCE

This application is based upon and claims priority to Chinese Patent Application No. 2023111877478, filed on Sep. 14, 2023, the entire contents thereof are incorporated herein by reference.

### TECHNICAL FIELD

The disclosed embodiments relate to the technical field of electronic control devices, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

A high-voltage DC relay is a type of relay. In the prior art, the high-voltage DC relay includes a pair of static contact leading-out terminals and a movable assembly. The movable assembly includes a movable contact piece and a push rod assembly, and the movable contact piece is installed on the push rod assembly through an elastic assembly. In the over-travel stage, the movable contact piece is in contact with the pair of static contact leading-out terminals, the push rod assembly will continue to move upward, and the elastic assembly will be compressed to form contact pressure.

However, the movable contact piece of the high-voltage DC relay in the prior art is easy to rotate relative to the push rod assembly, causing the movable contact piece to deflect excessively, thereby causing the contact positions of the movable contact and the static contact to be inconsistent, thereby causing the contact resistance to be unstable, affecting the reliability of the relay.

### SUMMARY

The relay of the embodiment of the present disclosure includes:
a movable contact assembly comprising a movable contact piece;
a push rod assembly configured to push the movable contact assembly to move, to make the movable contact piece contact with or separate from a static contact leading-out terminal;
a limiting component connected to the movable contact assembly and the push rod assembly, and configured to restrict the movable contact assembly from rotating around an axis of the push rod assembly relative to the push rod assembly; and
an elastic assembly configured to provide a contact pressure.

According to some embodiments of the present disclosure, wherein the limiting component can be deformed to adapt to over-travel.

According to some embodiments of the present disclosure, wherein the elastic assembly is a first elastic piece;
the first elastic piece connected to one of the push rod assembly and the movable contact assembly, and abuts against another one of the push rod assembly and the movable contact assembly.

According to some embodiments of the present disclosure, wherein the first elastic piece and the movable contact assembly together form an accommodation chamber, the limiting component is disposed in the accommodation chamber.

According to some embodiments of the present disclosure, wherein the relay further comprises a pair of static contact leading-out terminals, both ends of the movable contact piece along a first direction are configured to contact with or separate from the pair of static contact leading-out terminals respectively; wherein the first direction is an arrangement direction of the pair of static contact leading-out terminals;
the first elastic piece comprises a first base portion and elastic arms, the first base portion is connected to the push rod assembly through a first anti-rotation structure, both ends of the first base portion along the first direction are provided at least one of the elastic arms;
the elastic arms at both ends of the first base portion along the first direction are respectively abuts against both ends of the movable contact piece along the first direction.

According to some embodiments of the present disclosure, wherein the elastic arm comprises an extension portion and an abutting portion, the extension portion is connected to the first base portion, the abutting portion is connected to one end of the extension portion far away from the first base portion, and abuts against one end of the movable contact piece along the first direction; wherein a width of an end of the extension portion connected to the first base portion is greater than a width of an end of the extension portion connected to the abutting portion.

According to some embodiments of the present disclosure, wherein the width of the extension portion gradually decreases from the first base portion to the abutting portion.

According to some embodiments of the present disclosure, wherein the first anti-rotation structure comprises:
at least two first limiting protrusions disposed on one of the push rod assembly and the first base portion; and
at least two first limiting holes disposed on another one of the push rod assembly and the first base portion; wherein the at least two first limiting protrusions are inserted into the at least two first limiting holes respectively.

According to some embodiments of the present disclosure, wherein the limiting component is a second elastic piece, the second elastic piece is connected to one of the elastic assembly and the movable contact assembly through a second anti-rotation structure, and connected to another one of the elastic assembly and the movable contact assembly through a third anti-rotation structure.

According to some embodiments of the present disclosure, wherein the second anti-rotation structure comprises:
at least two second limiting protrusions disposed on one of the elastic assembly and the second elastic piece;
at least two second limiting holes disposed on another one of the elastic assembly and the second elastic piece; wherein the at least two second limiting protrusions are inserted into the at least two second limiting holes respectively.

According to some embodiments of the present disclosure, wherein the elastic assembly is connected to the push rod assembly through a first anti-rotation structure; the first anti-rotation structure comprises at least two first limiting protrusions and at least two first limiting hole, the at least two first limiting protrusions are disposed on the push rod assembly, the at least two first limiting hole are disposed on the elastic assembly, the at least two first limiting protrusions are inserted into the at least two first limiting holes respectively;
each of the second limiting protrusions is a protruding ring, one protruding ring surrounds one first limiting hole; an inner ring surface of the protruding ring is flush with a hole wall of the first limiting hole.

According to some embodiments of the present disclosure, wherein the protruding ring is formed by turning and bending a hole edge of the first limiting hole of the elastic assembly towards a direction close to the movable contact assembly.

According to some embodiments of the present disclosure, wherein the relay further comprises a pair of static contact leading-out terminals, both ends of the movable contact piece along the first direction are configured to contact with or separate from the pair of static contact leading-out terminals; wherein the first direction is an arrangement direction of the pair of static contact leading-out terminals;
the second elastic piece comprises a second base portion, a deformation portion and a connection portion;
the second base portion is connected to one of the elastic assembly and the movable contact assembly through a second anti-rotation structure, both sides of the second base portion along the first direction are provided with the deformation portion and the connection portion, the second base portion is connected to the connection portion through the deformation portion; the connection portion is connected to another one of the elastic assembly and the movable contact assembly through a third anti-rotation structure.

According to some embodiments of the present disclosure, wherein along the first direction, the connection portion located at one side of the second base portion and the movable contact assembly form a first joint, the connection portion located at another side of the second base portion and the movable contact assembly form a second joint,
there is a first distance between the first joint and the second joint, there is a second distance between the deformation ports at both sides of the second base port, and the first distance is smaller than the second distance; where in the second distance is a maximum distance between the deformation portions at both sides of the second base portion.

According to some embodiments of the present disclosure, wherein the third anti-rotation structure comprises:
at least two third limiting protrusions disposed on one of the second elastic piece and the movable contact assembly; and
at least two third limiting holes disposed on another one of the second elastic piece and the movable contact assembly; the at least two third limiting protrusions are inserted into the at least two third limiting holes.

According to some embodiments of the present disclosure, wherein the relay further comprises a first magnetizer;
the first magnetizer is disposed at a side of the movable contact assembly facing the static contact leading-out terminal, and configured to resist an electric repulsion force.

According to some embodiments of the present disclosure, wherein the movable contact assembly further comprises a second magnetizer, the second magnetizer is fixedly connected to a side of the movable contact piece facing away from the static contact leading-out terminal; the second magnetizer is configured to form a magnetic circuit with the first magnetizer.

According to some embodiments of the present disclosure, wherein the relay further comprises a pair of static contact leading-out terminals, both ends of the movable contact piece along a first direction are configured to contact with or separate from the pair of static contact leading-out terminals; wherein the first direction is an arrangement direction of the pair of static contact leading-out terminals;
the limiting component is a second elastic piece, the second elastic piece comprises a second base portion, a deformation portion and a connection portion;
both sides of the second base portion along the first direction are provided with the deformation portion and the connection portion, the second base portion is connected to the connection portion through the deformation portion; the second base portion is connected to the elastic assembly;
the connection portions at both sides of the second base portion are respectively inserted between the second magnetizer and the movable contact piece from two sides of the second magnetizer along the first direction, and fixedly connected to the movable contact piece and the second magnetizer.

According to some embodiments of the present disclosure, wherein the elastic assembly is a first elastic piece, the limiting component is a second elastic piece, a thickness of the second elastic piece is smaller than a thickness of the first elastic piece.

According to some embodiments of the present disclosure, wherein the elastic assembly is a compression spring, the compression spring is configured to provide contact pressure.

According to some embodiments of the present disclosure, wherein one end of the compression spring abuts against the limiting component, another end of the compression spring abuts against the movable contact assembly or the push rod assembly.

According to some embodiments of the present disclosure, wherein the limiting component is a second elastic piece;
the second elastic piece comprises a second base portion, a deformation portion and a connection portion; the second base portion is connected to the push rod assembly, both sides of the second base portion along the first direction are provided with the deformation portion and the connection portion, the second base portion is connected to the connection portion through the deformation portion; the connection portion is connected to the movable contact assembly; wherein the first direction is an arrangement direction of the pair of static contact leading-out terminals;
the second elastic piece and the movable contact assembly surround and form a chamber, the compression spring is disposed in the chamber, and one end of the compression spring abuts against the second base portion, and another end of the compression spring abuts against the movable contact assembly.

According to some embodiments of the present disclosure, wherein the relay further comprises a pair of static contact leading-out terminals, both ends of the movable contact piece along a first direction are configured to contact with or separate from the pair of static contact leading-out terminals; wherein the first direction is an arrangement direction of the pair of static contact leading-out terminals;
the elastic assembly and the push rod assembly are connected in a limited way along the first direction; and/or, the limiting component and the movable contact assembly are connected in a limited way along the first direction; and/or, the limiting component and the elastic assembly are connected in a limited way along the first direction.

According to some embodiments of the present disclosure, wherein the push rod assembly comprises a contact bracket, the movable contact assembly comprises one or more movable contact pieces, the movable contact assembly is installed in the contact bracket through the elastic assembly.

### BRIEF DESCRIPTION OF THE DRAWINGS

FIG. 1 is a schematic structure diagram of the relay according to a first exemplary embodiment.

FIG. 2 is a cross-sectional view along line A-A in FIG. 1.

FIG. 3 is a cross-sectional view along line B-B in FIG. 1.

FIG. 4 is a schematic structure diagram of the movable assembly and the second magnetizer according to an exemplary embodiment.

FIG. 5 is an exploded schematic diagram of FIG. 4.

FIG. 6 is a schematic structure diagram of FIG. 4, wherein the contact bracket is omitted, the movable contact piece has not yet contacted the static contact leading-out terminal.

FIG. 7 is a schematic structure diagram of the first elastic piece according to an exemplary embodiment.

FIG. 8 is a schematic structure diagram of the second elastic piece according to an exemplary embodiment.

FIG. 9 is a cross-sectional view along line C-C in FIG. 4.

FIG. 10 is a partial enlarged view of X in FIG. 9.

FIG. 11 is a schematic structure diagram of the movable assembly and two second magnetizers of the relay according to the second exemplary embodiment, wherein the contact bracket is omitted in the movable assembly.

FIG. 12 is an exploded schematic view of the movable assembly and two second magnetizers of the relay according to the second exemplary embodiment.

FIG. 13 is a schematic structure diagram of the movable assembly and two second magnetizers of the relay according to the third exemplary embodiment, wherein the contact bracket is omitted in the movable assembly.

FIG. 14 is a sectional view of FIG. 13.

FIG. 15 is a schematic structure diagram of the movable assembly and two second magnetizers of the relay according to the fourth exemplary embodiment.

FIG. 16 is a schematic structure diagram of the movable assembly and two second magnetizers of the relay according to the fifth exemplary embodiment.

FIG. 17 is a schematic structure diagram of the movable assembly and two second magnetizers of the relay according to the sixth exemplary embodiment, wherein the contact bracket is omitted in the movable assembly.

FIG. 18 is a schematic structure diagram of FIG. 4, omitting the contact bracket, wherein the movable contact piece has contacted the static contact leading-out terminal.

wherein, the reference numerals are listed as follows:
1000, contact container; 1001, contact chamber; 1002, first through hole; 1100, insulating cover; 1110, ceramic cover; 1111, third through hole; 1120, frame piece; 1200, yoke plate; 1210, second through hole; 2000, static contact leading-out terminal; 3000, movable assembly; 3100, movable contact assembly; 3110, movable contact piece; 3200, push rod assembly; 3210, push rod; 3211, base; 3212, rod portion; 3213, clamping sheet; 3214, first limiting protrusions; 3220, contact bracket; 3221, top wall; 3222, side wall; 3223, clamping hole; 3230, elastic assembly; 4000, magnetic circuit part; 4100, bobbin; 4200, coil; 4300, static iron core; 4 400, movable iron core; 4410, penetrating hole; 4500, reset piece; 5000, metal cover; 6100, first magnetizer; 6200, second magnetizer; 6300, connection piece; 100, first elastic piece; 110, first base portion; 111, first limiting holes; 112, protruding ring; 112a, top surface; 112b, inner ring surface; 113, chamfer; 120, elastic arm; 121, extension portion; 122, abutting portion; 200, first anti-rotation structure; 300, limiting component; 300a, second elastic piece; 310, second base portion; 311, second limiting holes; 320, deformation portion; 330, connection portion; 400, second anti-rotation structure; 410, second limiting protrusions; 500, accommodation chamber; 600, compression spring; 700, third anti-rotation structure; 700a, first joint; 700b, second joint; 710, third limiting protrusions; 720, third limiting holes; 800, chamber.

### DETAILED DESCRIPTION

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete, and will fully convey the concepts of the examples.

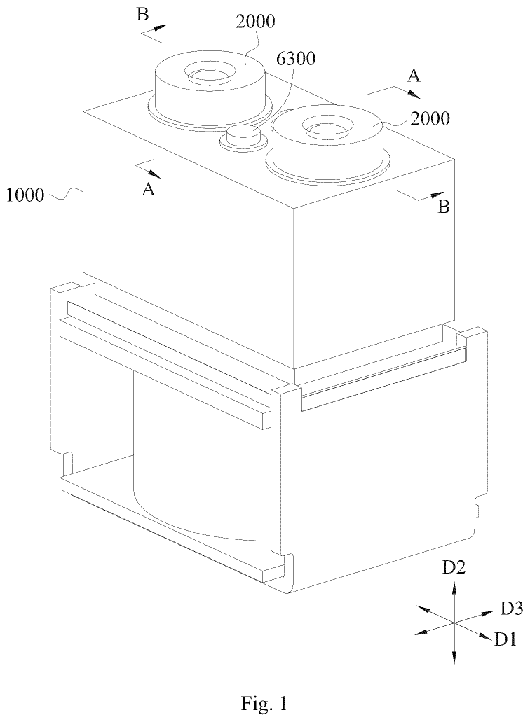

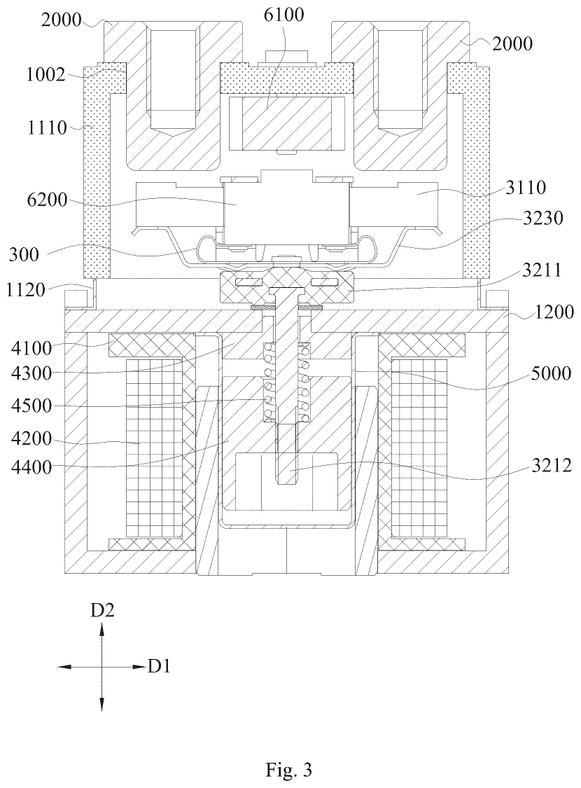

As shown in FIG. 1 to FIG. 3, the relay of the embodiment of the present disclosure includes a contact container 1000, a pair of static contact leading-out terminals 2000, a movable assembly 3000 and a magnetic circuit part 4000.

It is understood that the terms “include” and “have” and any of their variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

It should be noted that the contact container 1000 is a stationary component, which is used to accommodate the contact group and is mainly a housing with a chamber. In addition, the contact container 1000 can be composed of multiple components connected in a predetermined assembly manner.

The contact container 1000 has a contact chamber 1001 therein. The contact container 1000 may include an insulating cover 1100 and a yoke plate 1200. The insulating cover 1100 is covered on one side surface of the yoke plate 1200. The insulating cover 1100 and the yoke plate 1200 together enclose the contact chamber 1001.

The insulating cover 1100 includes a ceramic cover 1110 and a frame piece 1120. The ceramic cover 1110 is connected to the yoke plate 1200 through the frame piece 1120. The frame piece 1120 may be a metal piece of an annular structure, such as an iron-nickel alloy, and one end of the frame piece 1120 is connected to an opening edge of the ceramic cover 1110, for example, by laser welding, brazing, resistance welding, gluing, etc. The other end of the frame piece 1120 is connected to the yoke plate 1200, which may also be laser welding, brazing, resistance welding, gluing, etc. The frame piece 1120 is arranged between the ceramic cover 1110 and the yoke plate 1200, which can facilitate the connection between the ceramic cover 1110 and the yoke plate 1200.

The contact container 1000 also has a pair of first through holes 1002, the first through holes 1002 are communicated with the contact chamber 1001. The first through holes 1002 are used for the static contact leading-out terminal 2000 to pass through. In the embodiment of the present disclosure, the first through holes 1002 are opened on the ceramic cover 1110.

The pair of static contact leading-out terminals 2000 are connected to the ceramic cover 1110 of the contact container 1000, and at least a portion of each static contact leading-out terminal 2000 is located in the contact chamber 1001. One of the pair of static contact leading-out terminals 2000 is used as a terminal for current to flow in and the other is used as a terminal for current to flow out.

The pair of static contact leading-out terminals 2000 are respectively disposed in the pair of first through holes 1002 and connected to the ceramic cover 1110, for example, by welding.

The bottom of static contact leading-out terminal 2000 serves as a static contact, and the static contact may be integrally or separately arranged at the bottom of the static contact leading-out terminal 2000.

Continuing to refer to FIG. 1 to FIG. 3, the movable assembly 3000 includes a movable contact assembly 3100, a push rod assembly 3200 and an elastic assembly 3230. The movable contact assembly 3100 is disposed in the insulating cover 1100 and is mounted on the push rod assembly 3200 through the elastic assembly 3230. The two ends of the movable contact assembly 3100 along the first direction D1 are used to contact the pair of static contact leading-out terminals 2000 contact or separation. The first direction D1 is the arrangement direction of the pair of static contact leading-out terminals 2000.

The movable contact assembly 3100 includes a movable contact piece 3110, and the movable contact piece 3110 may include a movable piece body and movable contacts disposed at both ends of the movable piece body. The movable contact may be a separate part and connected to the movable piece body. Of course, the movable contact may also be integrally formed on the movable piece body.

The movable contact assembly 3100 includes at least one movable contact piece 3110, such as one, two, three, etc. In the embodiment of the present disclosure, the movable contact assembly 3100 includes two movable contact pieces 3110 arranged side by side. One end of the two movable contact pieces 3110 in the first direction D1 is used to contact with or separate from the static contact of one static contact leading-out terminal 2000, and the other end of the two movable contact pieces 3110 in the first direction D1 is used to contact with or separate from the static contact of another static contact leading-out terminal 2000.

The movable contact assembly 3100 may further include a second magnetizer 6200, the second magnetizer 6200 is fixedly connected to the movable contact piece 3110 facing away from the static contact leading-out terminal 2000. The role of the second magnetizer 6200 will be described below.

Wherein in the movable contact assembly 3100, the number of the movable contact piece 3110 is equal to the number of the second magnetizer 6200. Specifically, when the number of the movable contact piece 3110 is one, the number of the second magnetizer 6200 is also one; When the number of the movable contact piece 3110 is multiple (including two), the number of the second magnetizer 6200 is also multiple. The multiple second magnetizers 6200 are fixedly connected to multiple sides of the multiple movable contact pieces 3110 facing away from the static contact leading-out terminal 2000 in a one-to-one correspondence.

Of course, in other embodiments, when the number of the movable contact piece 3110 is one, the number of the second magnetizer 6200 may also be multiple, for example, at least one opening is provided in the middle of the movable contact piece 3110, and two adjacent second magnetizers 6200 among the multiple second magnetizers 6200 are inserted into one opening.

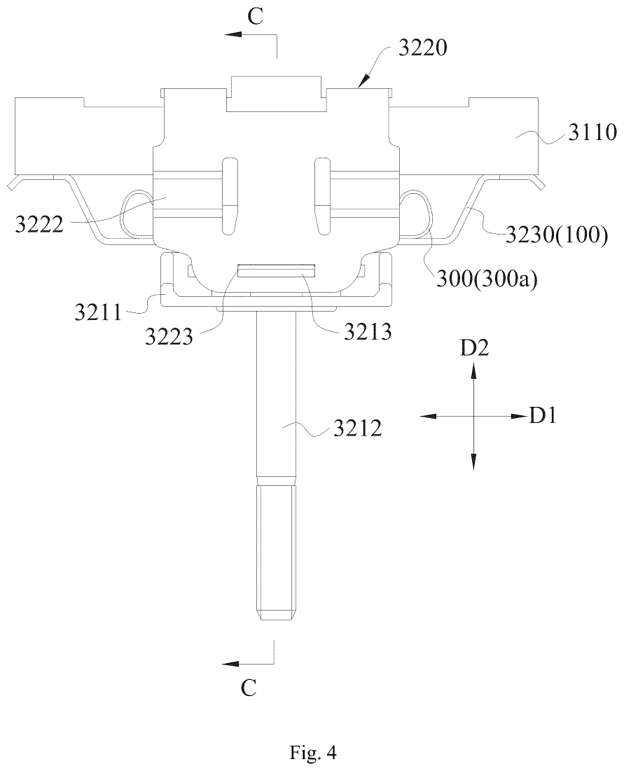

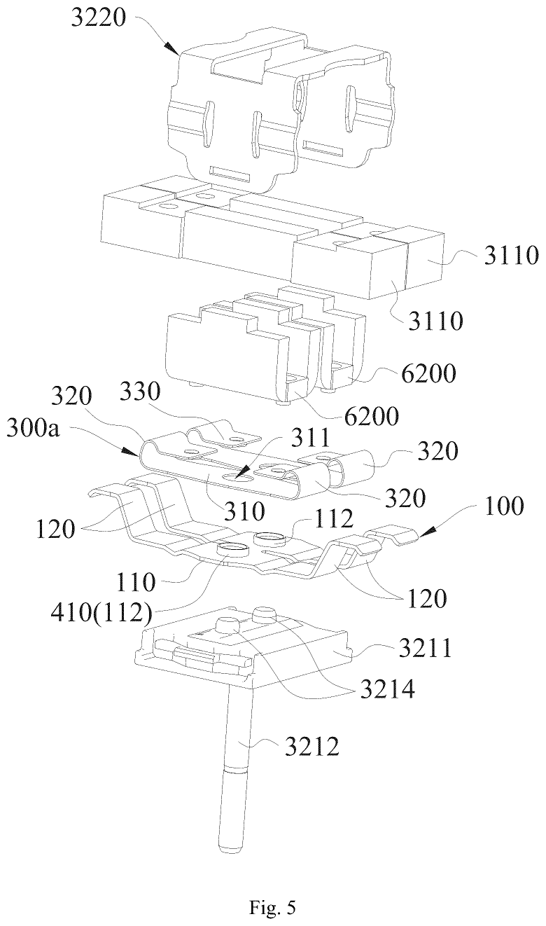

As shown in FIGS. 4 and 5, the moving direction of the movable contact piece 3110 is defined as the second direction D2, and the direction perpendicular to the first direction D1 and the second direction D2 is defined as the third direction D3. The push rod assembly 3200 includes a push rod 3210, a contact bracket 3220, and an elastic assembly 3230. The contact bracket 3220 includes a top wall 3221 and two side walls 3222, and the two side walls 3222 are integrally connected to two side edges of the top wall 3221 along the third direction D3, that is, an inverted U-shaped bracket is formed. The movable contact assembly 3100 is installed in the contact bracket 3220 through the elastic assembly 3230. The upper end of the push rod 3210 is connected to the bottom ends of the two side walls 3222 of the contact bracket 3220.

Each side wall 3222 of the contact bracket 3220 is provided with a clamping hole 3223. The push rod 3210 includes a base 3211 and a rod portion 3212, and the base 3211 is connected to one axial end of the rod portion 3212. Clamping sheets 3213 are provided on both sides of the base 3211, and two clamping sheets 3213 are respectively inserted into the two clamping holes 3223 of the contact bracket 3220 to fix the base 3211 and the contact bracket 3220. The elastic assembly 3230 is provided between the movable contact assembly 3100 and the base 3211, and is used to apply an elastic force to the movable contact assembly 3100 to move toward the top wall 3221, to provide contact pressure. In the embodiment of the present disclosure, one end of the elastic assembly 3230 abuts against the movable contact assembly 3100, and the other end of the elastic assembly 3230 is mounted on the base 3211.

Of course, in other embodiments, the contact bracket 3220 can also be other structures, which are not listed here one by one.

Wherein when the number of the movable contact piece 3110 is multiple, the plurality of movable contact pieces 3110 are arranged side by side along the third direction D3.

Referring back to FIGS. 1 to 3, the yoke plate 1200 has a second through hole 1210, which penetrates two opposite sides of the yoke plate 1200 along the thickness direction of the yoke plate 1200, and the second through hole 1210 is communicated with the contact chamber 1001 of the contact container 1000. The rod portion 3212 is movably disposed in the second through hole 1210 in the axial direction. The base 3211 at one axial end of the rod portion 3212 is disposed in the contact chamber 1001.

The relay further includes a metal cover 5000. The metal cover 5000 is connected to the side of the yoke plate 1200 facing away from the insulating cover 1100, and the metal cover 5000 covers the second through hole 1210 on the yoke plate 1200. The metal cover 5000 and the yoke plate 1200 enclose a chamber for accommodating the static iron core 4300 and the movable iron core 4400 of the magnetic circuit part 4000.

The magnetic circuit part 4000 includes a bobbin 4100, a coil 4200, a static iron core 4300, a movable iron core 4400 and a reset piece 4500. The bobbin 4100 is in a hollow cylindrical shape and is formed of an insulating material. The metal cover 5000 is inserted into the bobbin 4100. The coil 4200 surrounds the bobbin 4100. The static iron core 4300 is fixedly arranged in the metal cover 5000, and a part of the static iron core 4300 extends into the second through hole 1210. The static iron core 4300 has a penetrating hole 4410 arranged corresponding to the position of the second through hole 1210, and is used for the rod portion 3212 to be inserted therein. The movable iron core 4400 is movably arranged in the metal cover 5000, and is arranged opposite to the static iron core 4300 along the axial direction of the rod portion 3212. The movable iron core 4400 is connected to the rod portion 3212 and is used to be attracted by the static iron core 4300 when the coil 4200 is energized. The movable iron core 4400 and the rod portion 3212 can be connected by threading, riveting, welding or other methods.

The reset piece 4500 is located inside the metal cover 5000 and is disposed between the static iron core 4300 and the movable iron core 4400, and is used to reset the movable iron core 4400 when the coil 4200 is powered off. The reset piece 4500 may be a spring and is sleeved outside the rod portion 3212.

It should be noted that when the coil 4200 is energized, the magnetic circuit part 4000 can drive the rod portion 3212 to push the push rod assembly 3200 to move upward. When the movable contact piece 3110 contacts the static contact leading-out terminal 2000, the movable contact piece 3110 is stopped by the static contact leading-out terminal 2000, while the rod portion 3212 and the base 3211 will continue to move upward until the over-travel is completed.

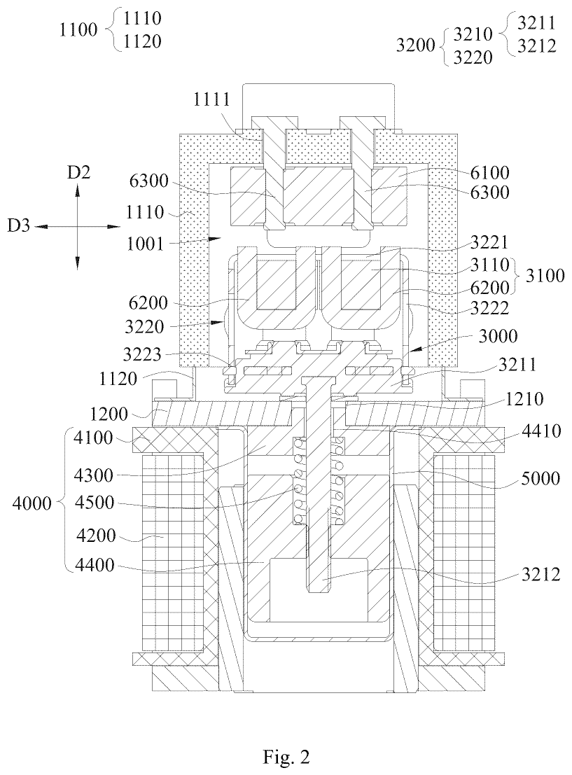

As shown in FIGS. 2 to 4, the relay of the embodiment of the present disclosure further includes a first magnetizer 6100. The movable contact piece 3110 has a first side and a second side disposed opposite to each other along the second direction D2. Wherein the first side faces the static contact leading-out terminal 2000, and the second side faces away from the static contact leading-out terminal 2000. The first magnetizer 6100 is disposed at the first side of the movable contact piece 3110 and is disposed in the contact chamber 1001.

When the movable contact assembly 3100 includes only the movable contact piece 3110 but not the second magnetizer 6200, after the movable contact piece 3110 is energized, the first magnetizer 6100 is magnetized, thereby forming an attraction force on the movable contact piece 3110 in the contact closing direction, and the attraction force can resist the electric repulsion force generated by the short-circuit current between the movable contact piece 3110 and the static contact leading-out terminal 2000, thereby preventing the movable contact piece 3110 from bouncing off from the static contact leading-out terminal 2000, thereby achieving the purpose of resisting short circuit.

When the movable contact assembly 3100 includes the movable contact piece 3110 and the second magnetizer 6200, the second magnetizer 6200 is fixedly connected to the movable contact piece 3110, and the second magnetizer 6200 is used to form a magnetic circuit with the first magnetizer 6100.

When both ends of the movable contact piece 3110 are in contact with the pair of static contact leading-out terminals, the second magnetizer 6200 moving together with the movable contact piece 3110 approaches or contacts the first magnetizer 6100, thereby forming a magnetic circuit around the movable contact piece 3110 between the first magnetizer 6100 and the second magnetizer 6200. When the short-circuit current passes through the movable contact piece 3110, a magnetic attraction force is generated between the first magnetizer 6100 and the second magnetizer 6200 in the direction of the contact pressure, and the magnetic attraction force can resist the electric repulsion force generated by the short-circuit current between the movable contact piece 3110 and the static contact leading-out terminal 2000, which ensures that the movable contact piece 3110 and the static contact leading-out terminal 2000 do not bounce off.

It is understood that the second magnetizer 6200 and the movable contact piece 3110 may be fixedly connected by riveting, but is not limited thereto.

The first magnetizer 6100 and the second magnetizer 6200 can both be straight-line or U-shaped, and the first magnetizer 6100 and the second magnetizer 6200 can be made of magnetic conductive materials such as iron, cobalt, nickel, and alloys thereof.

Wherein when the movable contact assembly 3100 includes a plurality of the movable contact pieces 3110 arranged side by side, the number of the first magnetizers 6100 may be plural, and the number of the first magnetizers 6100 corresponds to the number of the movable contact pieces 3110, and the plurality of first magnetizers 6100 are respectively located on one side of the plurality of movable contact pieces 3110 facing the static contact leading-out terminal 2000.

Of course, in other embodiments, when the movable contact assembly 3100 includes a plurality of movable contact pieces 3110 arranged side by side, the number of the first magnetizer 6100 may be one, and the first magnetizer 6100 spans across the plurality of movable contact pieces 3110 in the third direction D3.

The first magnetizer 6100 may be connected to the contact container 1000 via two connection pieces 6300. One end of the two connection pieces 6300 is connected to the contact container 1000, and the other end of the two connection pieces 6300 is connected to the first magnetizer 6100.

It is understandable that the first magnetizer 6100 is connected to the contact container 1000 through the connection piece 6300, so that the magnetic attraction force for resisting short circuit is transferred to the contact container 1000. Since the contact container 1000 is a stationary component, there is no need for too much holding force of the coil, thereby reducing the power consumption of the coil of the relay and the volume of the relay, and improving the anti-short circuit ability.

In one embodiment, the connection piece 6300 is rod-shaped, one end of the connection piece 6300 along the axial direction is fixedly connected to the ceramic cover 1110 of the insulating cover 1100, and the other end of the connection piece 6300 along the axial direction is connected to the first magnetizer 6100.

In the embodiment of the present disclosure, the top wall of the ceramic cover 1110 of the contact container 1000 is provided with a third through hole 1111, and the connection piece 6300 is inserted through the third through hole 1111. The connection method between the end of the connection piece 6300 and the ceramic cover 1110 may be various, such as welding, riveting, threading, bonding, etc. The connection method between the other end of the connection piece 6300 and the first magnetizer 6100 can also may be various, such as welding, riveting, threading, bonding, clamping, etc.

It is understandable that when one end of the connection piece 6300 is connected to the ceramic cover 1110 by welding, by welding the connection piece 6300 to the top wall of the ceramic cover 1110, the metallization layer can be processed only on the periphery of the third through hole 1111 on the outer wall of the top wall, without processing the metallization layer on the inner wall of the top wall, which is convenient for processing and simplifies the processing steps.

It is understood that one end of the connection piece 6300 may be connected to the outer wall surface of the ceramic cover 1110, may be connected to the inner wall surface of the ceramic cover 1110, or may be connected to both the outer wall surface and the inner wall surface of the ceramic cover 1110.

In the embodiment of the present disclosure, one end of the connection piece 6300 is connected to the periphery of the third through hole 1111 of the ceramic cover 1110.

It can be seen that the first magnetizer 6100 is connected to the ceramic cover 1110 through the connection piece 6300. On the one hand, the magnetic attraction force for resisting short circuit is transferred to the ceramic cover 1110, so there is no need for too much holding force of the coil, thereby reducing the power consumption of the coil of the relay and the volume of the relay, and improving the anti-short circuit ability; on the other hand, since the connection piece 6300 is connected to the ceramic cover 1110, it will not occupy too much space in the contact chamber 1001, ensuring the arc extinguishing space of the arc extinguishing component and the activity space of the push rod.

In addition, the first magnetizer 6100 is connected to the rod-shaped connection piece 6300, so that the first magnetizer 6100 and the connection piece 6300 can be connected in a variety of ways, such as riveting, laser welding, clamping, gluing, etc., enriching the connection methods.

As an example, the connection piece 6300 is a solid rod. Thus, the connection piece 6300 and the first magnetizer 6100 can be connected by riveting, making the connection more reliable. In addition, the solid rod has a higher support strength and is less prone to deformation.

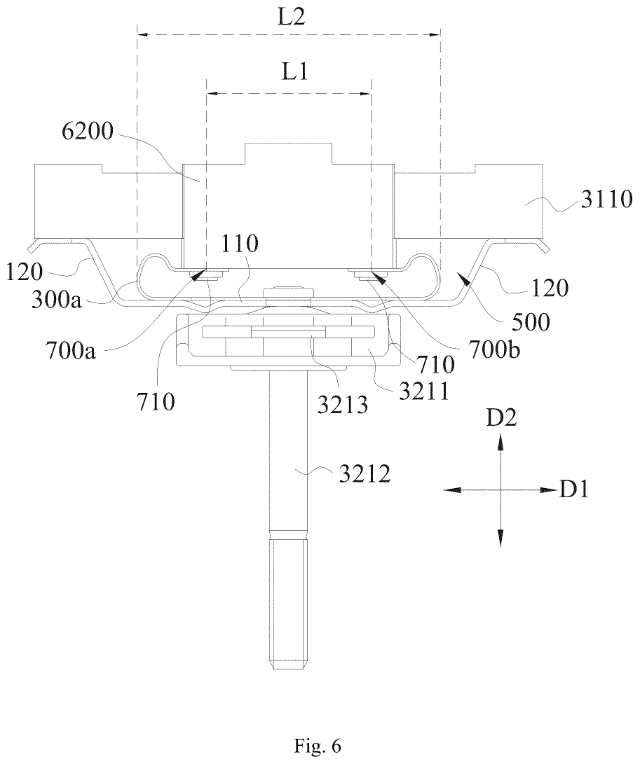

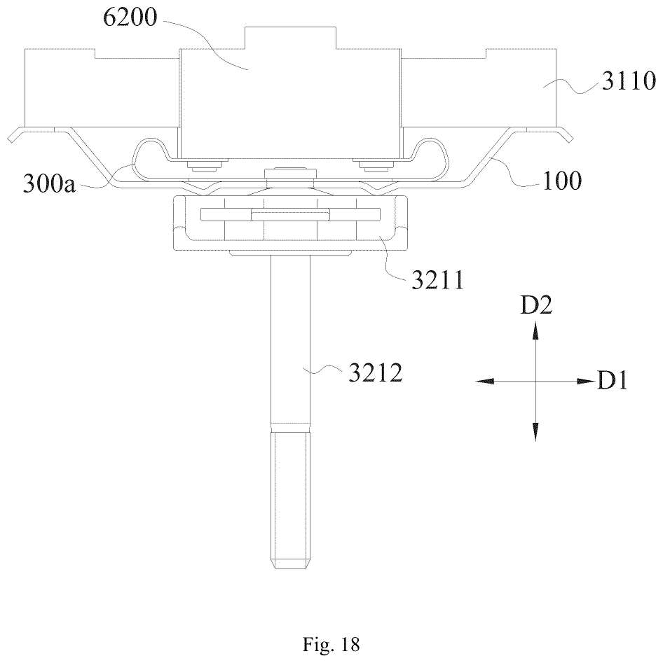

As shown in FIG. 5, FIG. 6 and FIG. 18, the relay further includes a limiting component 300, the limiting component 300 is connected to the movable contact assembly 3100 and the push rod assembly 3200, and is used to limit the rotation of the movable contact assembly 3100 relative to the push rod assembly 3200 around the axis of the push rod assembly 3200, and the limiting component 300 can be deformed to adapt to over-travel.

It can be understood that the limiting component 300 and the push rod assembly 3200 can be connected directly or indirectly. When the limiting component 300 and the push rod assembly 3200 are indirectly connected, the limiting component 300 can be connected to the push rod assembly 3200 through the elastic assembly 3230, that is, the elastic assembly 3230 and the push rod assembly 3200 are directly connected, and the limiting component 300 and the elastic assembly 3230 are directly connected.

The relay of the embodiment of the present disclosure includes a movable contact assembly 3100, a push rod 3210, a limiting component 300 and an elastic assembly 3230. Wherein the elastic assembly 3230 can provide contact pressure, and the limiting component 300 can limit the rotation of the movable contact assembly 3100 relative to the push rod 3210, thereby ensuring the consistency of the contact position of the movable contact and the static contact, enhancing the stability of the contact resistance, and improving the reliability of the relay.

It should be noted that, in the embodiment of the present disclosure, the limiting component 300 can limit the movable contact assembly 3100 to rotate about an axis perpendicular to the plane where the movable contact assembly 3100 is located. That is, the limiting component 300 can limit the movable contact assembly 3100 from rotating around the axis of the push rod assembly 3200 relative to the push rod assembly 3200.

In addition, when the number of the movable contact piece 3110 is plural, due to the anti-rotation function of the limiting component 300, only one contact bracket 3220 can be used, thereby avoiding the need to provide a contact bracket 3220 for each movable contact piece 3110 and increasing the occupied space.

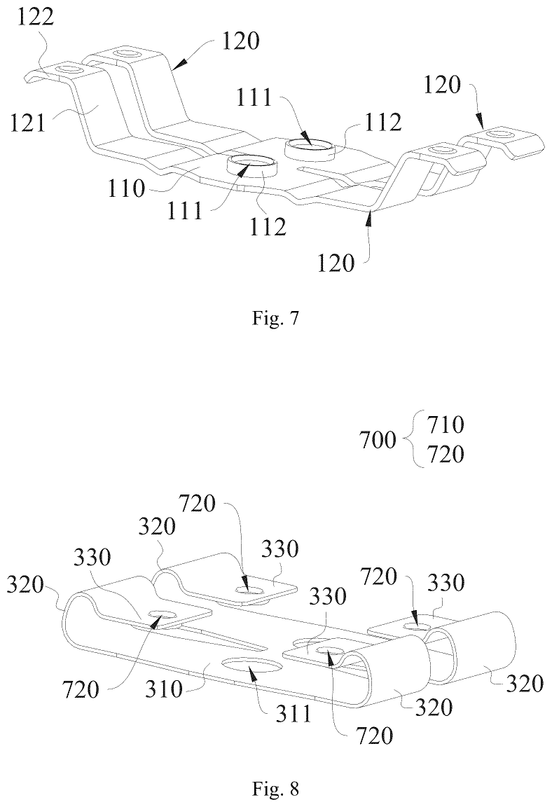

As shown in FIGS. 6 and 7, the elastic assembly 3230 is a first elastic piece 100. As an example, the first elastic piece 100 is a sheet structure made of a metal material and is formed by bending.

The first elastic piece 100 is mounted on the base 3211 of the push rod 3210 through the first anti-rotation structure 200, and abuts against the movable contact piece 3110 of the movable contact assembly 3100 at one side facing the push rod 3210.

The first elastic piece 100 is provided at the second side of the movable contact piece 3110 and includes a first base portion 110 and an elastic arm 120. The first base portion 110 is mounted on the push rod 3210 through the first anti-rotation structure 200, and at least one elastic arm 120 is provided at both ends of the first base portion 110 along the first direction D1; The elastic arms 120 at both ends of the first base portion 110 in the first direction D1 respectively abuts against both ends of the movable contact assembly 3100 in the first direction D1.

In the embodiment of the present disclosure, the elastic arm 120 at both ends of the first base portion 110 along the first direction D1 respectively abuts against both ends of the movable contact piece 3110.

It can be understood that, since the elastic arms 120 at both ends of the first elastic piece 100 are supported at both ends of the movable contact piece 3110, the movable contact piece 3110 and the second magnetizer 6200 can be stably mounted on the push rod 3210, thereby preventing the movable contact piece 3110 and the second magnetizer 6200 from shaking, and further preventing the problem of uneven contact pressure due to shaking of the movable contact piece 3110 and the problem of anti-short circuit ability being affected due to shaking of the second magnetizer 6200.

The first elastic piece 100 and the movable contact assembly 3100 together form an accommodation chamber 500, and the limiting component 300 is disposed in the accommodation chamber 500. By disposing the limiting component 300 in the accommodation chamber 500, the structure of the movable assembly 3000 can be made more compact, which is conducive to miniaturization of the relay.

As shown in FIG. 5, at both ends of the first base portion 110 in the first direction D1, at least two elastic arms 120 arranged side by side along the third direction D3 are provided, and the two corresponding elastic arms 120 of the first elastic piece 100 in the first direction D1 respectively abuts against the two ends of a movable contact piece 3110 in the first direction D1.

In the embodiment of the present disclosure, two elastic arms 120 arranged side by side along the third direction D3 are provided at both ends of the first base portion 110 in the first direction D1, the two elastic arms 120 at one end of the first base portion 110 in the first direction D1 respectively abuts against one end of the two movable contact pieces 3110 arranged side by side, and the two elastic arms 120 at the other end of the first base portion 110 in the first direction D1 respectively abuts against the other ends of the two movable contact pieces 3110 arranged side by side.

It can be seen that in the embodiment of the present disclosure, each movable contact piece 3110 corresponds to a pair of elastic arm 120, so that when the contact gaps of the plurality of movable contact pieces 3110 and the static contact leading-out terminal are inconsistent, the plurality of movable contact pieces 3110 will not interfere with each other.

As shown in FIG. 7, each elastic arm 120 includes an extension portion 121 and an abutting portion 122. Wherein the extension portion 121 is connected to the first base portion 110, and the abutting portion 122 is connected to an end of the extension portion 121 away from the first base portion 110 and abuts against the end of the movable contact piece 3110 in the first direction D1; Wherein the width of the end of the extension portion 121 connected to the first base portion 110 is greater than the width of the end of the extension portion 121 connected to the abutting portion 122. Further, the width of the extension portion 121 decreases in a direction from the first base portion 110 to the abutting portion 122.

In the embodiment of the present disclosure, the first elastic piece 100 includes a first base portion 110 and an elastic arm 120. Since the width of the extension portion 121 of the elastic arm 120 gradually decreases from the first base portion 110 to the abutting portion 122, that is, the width of the extension portion 121 gradually narrows, thereby reducing the structural strength of the elastic arm 120 to make the elastic arm 120 softer; In the initial stage of over-travel, after the movable contact piece 3110 and the static contact leading-out terminal 2000 just contact, the elastic arm 120 will not provide too much elastic force to avoid mismatching of suction and reaction forces; In addition, because the width of the extension portion 121 gradually narrows, the weight of the first elastic piece 100 can be slightly reduced; In addition, since the width of the extension portion 121 gradually decreases, the elastic arm 120 can reserve enough space in the third direction D3 for disposing other structures.

Furthermore, the width of the first base portion 110 is greater than the width of the extension portion 121. Since the first base portion 110 is connected to the push rod 3210 and the width of the first base portion 110 is relatively large and greater than the width of the extension portion 121, the structural strength of the first base portion 110 of the first elastic piece 100 can be ensured, so that the first elastic piece 100 can be firmly connected to the push rod 3210.

In addition, the extension portion 121 has a wide root and better mechanical strength, which is beneficial to improving the fatigue resistance of the first elastic piece 100. The extension portion 121 is gradually narrowed, so that the stiffness coefficient of the first elastic piece 100 changes nonlinearly, reducing the elastic reaction force in the initial stage and avoiding the mismatch of the suction and reaction forces at the beginning of over-travel. In addition, as the first elastic piece 100 is gradually compressed, its stiffness coefficient becomes larger and larger, ensuring that it can provide a sufficiently large contact pressure.

As shown in FIGS. 5 to 7, the first anti-rotation structure 200 includes at least two first limiting protrusions 3214 and at least two first limiting holes 111. The first limiting protrusions 3214 are provided on one of the first base portion 110 and the push rod assembly 3200, and the first limiting holes 111 are provided on the other one of the first base portion 110 and the push rod assembly 3200. The at least two first limiting protrusions 3214 are respectively inserted into the at least two first limiting holes 111 to achieve an anti-rotation effect.

In the embodiment of the present disclosure, the at least two first limiting protrusions 3214 are protruded on a side surface of the push rod 3210 facing the movable contact assembly 3100; the at least two first limiting holes 111 are provided on the first base portion 110.

In the embodiment of the present disclosure, the first anti-rotation structure 200 includes two first limiting protrusions 3214 and two first limiting holes 111. The two first limiting protrusions 3214 are convexly disposed on a side surface of the base 3211 facing the movable contact assembly 3100, and the two first limiting protrusions 3214 are arranged side by side along the third direction D3 and are respectively inserted into the two first limiting holes 111.

It should be noted that, since the first anti-rotation structure 200 of the embodiment of the present disclosure includes at least two first limiting protrusions 3214 and the first limiting holes 111 that cooperate with each other, the shape of the first limiting holes 111 can be circular.

Of course, in other embodiments, the first anti-rotation structure 200 may further include one first limiting protrusion 3214 and one first limiting hole 111, and the shape of the first limiting holes 111 is a non-circular shape such as a rectangle, an ellipse, or a triangle. The first limiting protrusion 3214 is adapted to the shape of the first limiting holes 111 and inserted into the first limiting holes 111, to prevent the push rod 3210 and the first elastic piece 100 from rotating relative to each other.

It can be understood that the first anti-rotation structure 200 is used to limit the rotation of the first elastic piece 100 relative to the push rod assembly 3200 around the axis of the push rod assembly 3200.

It can be understood that, in other embodiments, the first anti-rotation structure 200 may also include a riveted structure, a welded structure, an adhesive structure, etc. When the first anti-rotation structure 200 is a riveted structure, the first base portion 110 is riveted to the push rod assembly 3200; When the first anti-rotation structure 200 is a welded structure, the first base portion 110 is welded to the push rod assembly 3200; When the first anti-rotation structure 200 is an adhesive structure, the first base portion 110 is adhesively bonded to the push rod assembly 3200.

In another embodiment, the first anti-rotation structure 200 may further include a fastener that fastens the first elastic piece 100 and the push rod assembly 3200.

As shown in FIG. 5, FIG. 6 and FIG. 8, the limiting component 300 is a second elastic piece 300a, and the second elastic piece 300a may be a sheet-like structure made of a metal material and formed by bending. The second elastic piece 300a is connected to one of the elastic assembly 3230 and the movable contact assembly 3100 through the second anti-rotation structure 400, and is connected to the other one of the elastic assembly 3230 and the movable contact assembly 3100 through the third anti-rotation structure 700.

In the embodiment of the present disclosure, the second elastic piece 300a is connected to the first base portion 110 through the second anti-rotation structure 400, and is connected to the movable contact assembly 3100 through the third anti-rotation structure 700.

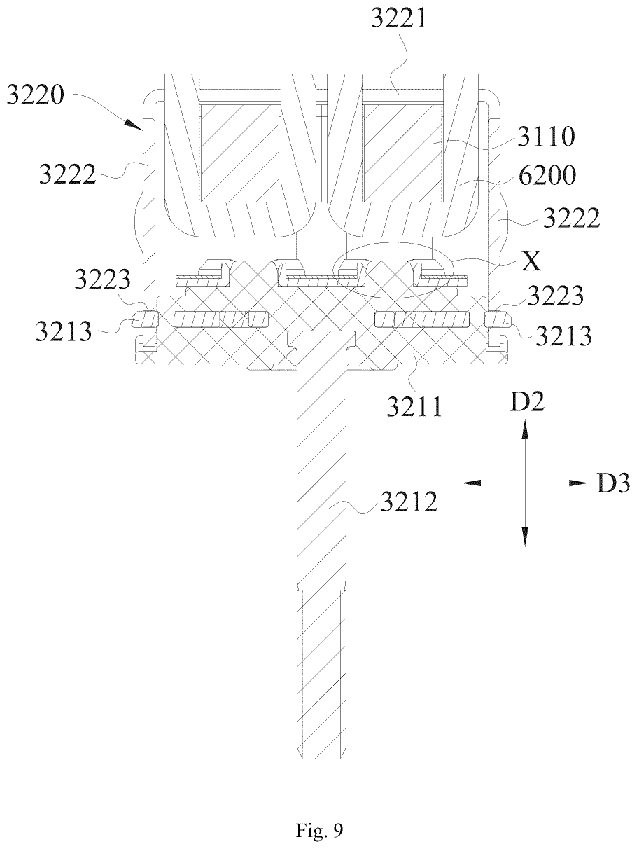

As shown in FIGS. 8 to 10, the second anti-rotation structure 400 includes at least two second limiting protrusions 410 and at least two second limiting holes 311. The second limiting protrusions 410 are provided on one of the first elastic piece 100 and the second elastic piece 300a, and the second limiting holes 311 are provided on the other one of the first elastic piece 100 and the second elastic piece 300a.

In the embodiment of the present disclosure, each second limiting protrusion 410 is a protruding ring 112. At least two protruding rings 112 are disposed on a side surface of the first base portion 110 facing the movable contact assembly 3100, and one protruding ring 112 surrounds one first limiting hole 111; The inner ring surface 112b of the protruding ring 112 is flush with the hole wall of the first limiting holes 111; The at least two second limiting holes 311 are disposed on the second elastic piece 300a; Wherein the at least two protruding rings 112 are respectively inserted into the at least two second limiting holes 311.

In the embodiment of the present disclosure, the second anti-rotation structure 400 includes two protruding rings 112 and two second limiting holes 311.

It should be noted that, since the second anti-rotation structure 400 of the embodiment of the present disclosure includes at least two protruding rings 112 and second limiting holes 311 that cooperate with each other, the shape of the second limiting holes 311 can be circular.

Of course, in other embodiments, the second anti-rotation structure 400 may further include one protruding ring 112 and one second limiting holes 311, and the second limiting holes 311 may be in a non-circular shape such as a rectangle, an ellipse, or a triangle. The protruding ring 112 is inserted into the second limiting holes 311 to prevent the second elastic piece 300a and the first elastic piece 100 from rotating relative to each other.

It can be understood that the second anti-rotation structure 400 is used to limit the rotation of the second elastic piece 300a relative to the first elastic piece 100 around the axis of the push rod assembly 3200.

In one embodiment, the protruding ring 112 is formed by turning and bending the edge of the first limiting holes 111 of the first base portion 110 toward the direction close to the movable contact assembly 3100. In the embodiment of the present disclosure, by arranging the protruding ring 112 on the edge of the first limiting holes 111, the friction between the first limiting protrusions 3214 and the first base portion 110 can be reduced when the first base portion 110 and the push rod 3210 are assembled, and the generation of scraps can be prevented. At the same time, the protruding ring 112 cooperates with the second limiting holes 311 of the second elastic piece 300a, and can also prevent the second elastic piece 300a from rotating relative to the first elastic piece 100. In addition, the folded protruding ring 112 can increase the contact area between the first limiting protrusions 3214 and the first base portion 110, and reduce the wear between the first limiting protrusions 3214 and the first base portion 110 during movement.

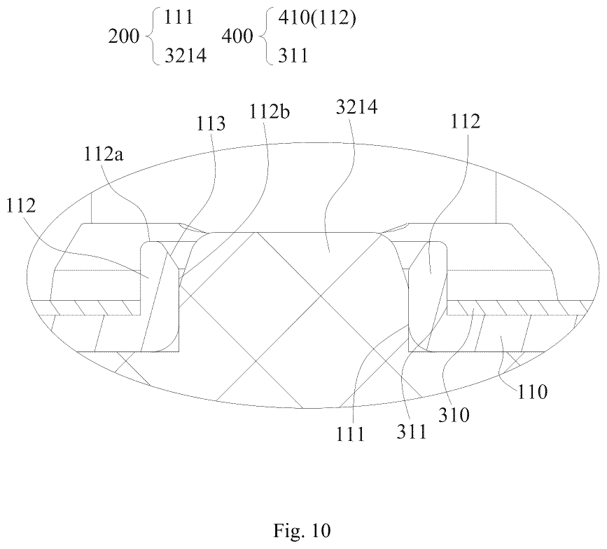

As shown in FIG. 10, the protruding ring 112 is provided with a top surface 112a facing away from the first base portion 110, and a chamfer 113 is provided at the connection between the top surface 112a and the inner ring surface 112b. By providing the chamfer 113 at the connection between the top surface 112a and the inner ring surface 112b, burrs generated during the molding of the protruding ring 112 can be eliminated, and scraping can be further prevented from being generated between the first limiting protrusions 3214 and the inner ring surface 112b of the protruding ring 112.

It can be understood that, in other embodiments, the second anti-rotation structure 400 may also include a riveted structure, a welded structure, an adhesive structure, etc. When the second anti-rotation structure 400 is a riveted structure, the first elastic piece 100 and the second elastic piece 300a are riveted; When the second anti-rotation structure 400 is a welded structure, the first elastic piece 100 and the second elastic piece 300a are welded; When the second anti-rotation structure 400 is an adhesive structure, the first elastic piece 100 and the second elastic piece 300a are adhesively bonded.

In another embodiment, the second anti-rotation structure 400 may further include a fastener that fastens the first elastic piece 100 and the second elastic piece 300a.

Referring to FIG. 6 and FIG. 8, the second elastic piece 300a is disposed at the second side of the movable contact assembly 3100. The second elastic piece 300a includes a second base portion 310, a deformation portion 320 and a connection portion 330. The second base portion 310 is installed on one of the first elastic piece 100 and the movable contact assembly 3100 through the second anti-rotation structure 400. The second base portion 310 is provided with the deformation portion 320 and the connection portion 330 on both sides along the first direction D1, and the second base portion 310 is connected to the connection portion 330 through the deformation portion 320; The connection portion 330 is connected to the other one of the first elastic piece 100 and the movable contact assembly 3100 through the third anti-rotation structure 700.

In the embodiment of the present disclosure, the connection portion 330 of the second elastic piece 300a is connected to the movable contact assembly 3100 through the third anti-rotation structure 700, and the second base portion 310 is installed on the first base portion 110 of the first elastic piece 100 through the second anti-rotation structure 400, so that the second elastic piece 300a can position the movable contact assembly 3100 in the second direction D2, and limit the movable contact assembly 3100 in the first direction D1 and the third direction D3, so that the second elastic piece 300a limits the movable contact assembly 3100, avoids the movable contact assembly 3100 from rotating relative to the push rod 3210, thereby avoiding the influence on the reliability of the relay due to the inability to align the movable contact and the static contact. In addition, the movable contact assembly 3100 is limited by the second elastic piece 300a, avoiding the movable contact assembly 3100 from rotating relative to the push rod 3210. The ripple noise caused by the contact between the movable contact assembly 3100 and the contact bracket when the movable contact assembly 3100 is powered on.

In addition, since the movable contact assembly 3100 does not rotate, it can reduce to a certain extent or even prevent the movable contact assembly 3100 from contacting the side wall of the contact bracket 3220, thereby avoiding the generation of large ripple noise (metal friction noise). In addition, it is avoided that the matching clearance becomes larger due to the increase of friction times and severe wear, which leads to the increase of deflection force and friction resistance. Furthermore, it can also reduce the metal particles generated by the friction between the movable contact assembly 3100 and the contact bracket 3220, reduce the probability of metal particles falling on the contact surface of the contacts, and thus reduce the quality risk of contact resistance increasing or even non-conduction.

Wherein during the over-travel process, the push rod 3210 continues to move toward the movable contact assembly 3100, and the deformation portion 320 is compressed and deformed, which does not affect the over-travel.

In addition, since the first elastic piece 100 is used to provide contact pressure, and the second elastic piece 300a does not need to provide contact pressure, the thickness of the second elastic piece 300a can be smaller than the thickness of the first elastic piece 100, thereby reducing the stress at the bending part of the second elastic piece 300a and avoiding fatigue fracture of the second elastic piece 300a.

In the embodiment of the present disclosure, two deformation portions 320 and two connection portions 330 are provided on both sides of the second base portion 310 along the first direction D1. One side of the second base portion 310 is connected to the two connection portions 330 through the two deformation portions 320. The two deformation portions 320 located on one side of the second base portion 310 are arranged side by side along the third direction D3. The two connection portions 330 located on one side of the second base portion 310 are fixedly connected to the two movable contact assemblies 3100 respectively.

It can be seen that in the embodiment of the present disclosure, each movable contact piece 3110 corresponds to a pair of connection portion 330, so that when the contact gaps of the plurality of movable contact pieces 3110 and the static contact leading-out terminal are inconsistent, the plurality of movable contact pieces 3110 will not interfere with each other.

As shown in FIG. 6, along the first direction D1, the connection portion 330 located on one side of the second base portion 310 and the movable contact assembly 3100 form a first joint 700a, and the connection portion 330 located on the other side of the second base portion 310 and the movable contact assembly 3100 form a second joint 700b. The first joint 700a and the second joint 700b have a first distance L1 between them, and the deformation portions 320 on both sides of the second base portion 310 have a second distance L2 between them, and the first distance L1 is smaller than the second distance L2. Wherein the first distance L1 is the distance between the center line of the first joint 700a and the center line of the second joint 700b, and the second distance L2 is the maximum distance between the deformation portions 320 on both sides of the second base portion 310.

In the embodiment of the present disclosure, since the first distance L1 is smaller than the second distance L2, during the over-travel process, the second elastic piece 300a is compressed by the push rod 3210 and the movable contact assembly 3100, so that the deformation portions 320 on both sides of the second base portion 310 can be deformed in directions away from each other (the deformation portions 320 on both sides expand outward), thereby preventing the second elastic piece 300a from being stuck and unable to provide contact pressure. In addition, since the first distance L1 is smaller than the second distance L2, the deformation portions 320 on both sides of the second base portion 310 are equivalent to being bent in directions approaching each other as a whole, thereby reducing the overall volume of the second elastic piece 300a and reducing the space occupancy rate.

Of course, in other embodiments, when the internal space of the relay is large enough, the first distance L1 may also be greater than the second distance L2.

As shown in FIGS. 6 and 8, the third anti-rotation structure 700 includes at least two third limiting protrusions 710 and at least two third limiting holes 720. Wherein the at least two third limiting protrusions 710 are provided on one of the second elastic piece 300a and the movable contact assembly 3100, and the at least two third limiting holes 720 are provided on the other one of the second elastic piece 300a and the movable contact assembly 3100. The at least two third limiting protrusions 710 are respectively inserted into the at least two third limiting holes 720.

In the embodiment of the present disclosure, the number of the third limiting holes 720 is four, and the number of the third limiting protrusions 710 is four. Four third limiting holes 720 are respectively disposed on four connection portions 330, and the four third limiting protrusions 710 are disposed on two second magnetizers 6200, and each second magnetizer 6200 is provided with two third limiting protrusions 710.

It can be understood that, in other embodiments, the third anti-rotation structure 700 may also include a riveted structure, a welded structure, an adhesive structure, etc. When the third anti-rotation structure 700 is a riveted structure, the second base portion 310 is riveted to the first elastic piece 100 or the movable contact assembly 3100; When the third anti-rotation structure 700 is a welded structure, the second base portion 310 is welded to the first elastic piece 100 or the movable contact assembly 3100; When the third anti-rotation structure 700 is an adhesive structure, the second base portion 310 is adhesively bonded to the first elastic piece 100 or the movable contact assembly 3100.

In another embodiment, the third anti-rotation structure 700 may further include a fastener. The fastener fastens one of the first elastic piece 100 and the movable contact assembly 3100 to the second elastic piece 300a.

In one embodiment, the elastic assembly 3230 is connected to the push rod assembly 3200 in a limited way along the first direction D1; and/or, the limiting component 300 is connected to the movable contact assembly 3100 in a limited way along the first direction D1; and/or, the limiting component 300 is connected to the elastic assembly 3230 in a limited way along the first direction D1. In this way, the amplitude of the movable contact assembly 3100 running relative to the push rod assembly 3200 in the first direction D1 can be reduced, thereby improving the overall impact resistance of the relay.

Preferably, the elastic assembly 3230 is connected to the push rod assembly 3200 in a limited way along the first direction D1, and the limiting component 300 is connected to the movable contact assembly 3100 in a limited way along the first direction D1, and the limiting component 300 is connected to the elastic assembly 3230 in a limited way along the first direction D1. In this way, when the relay encounters a large impact, the movable contact and the static contact will not shift, avoiding unstable contact resistance.

In another embodiment, the third limiting holes 720 are elliptical in shape, and the major axis of the ellipse is parallel to the first direction D1. By designing the third limiting holes 720 to be elliptical, before the movable contact and the static contact are in contact, the third limiting protrusions 710 are limited to the outer edge of the third limiting holes 720, so that the movable contact assembly 3100 does not run. After the movable contact and the static contact are in contact, the second elastic piece 300a is compressed, and the connection portion and the deformation portions on both sides of the second base portion 310 have a tendency to move to both sides. At this time, the elliptical third limiting holes 720 can provide space for the connection portion 330 to move, so as to release the stress generated inside the second elastic piece 300a after being compressed, and prevent the internal stress of the second elastic piece 300a from being too concentrated and affecting its service life.

In addition, it is worth noting that, since the distance that the connection portion 330 moves within the ellipse is small, it does not affect the relative position of the movable contact and the stationary contact.

It is understood that the first anti-rotation structure 200, the second anti-rotation structure 400 and the third anti-rotation structure 700 may be the same or different.

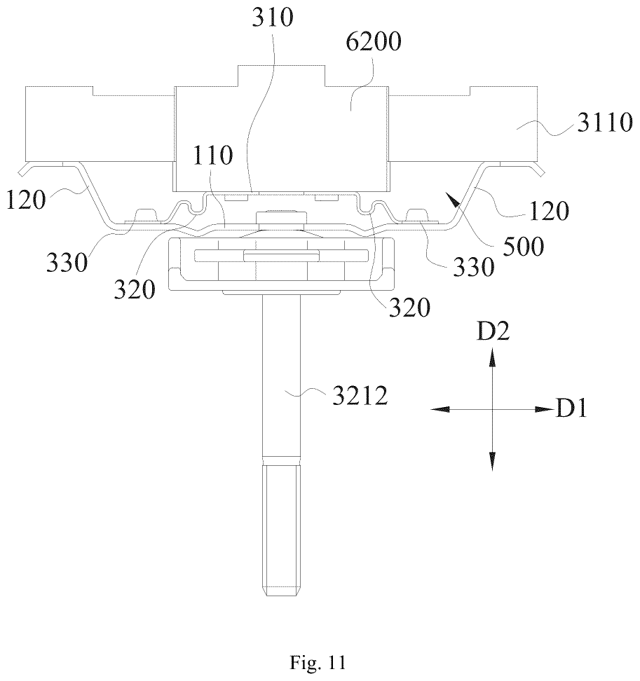

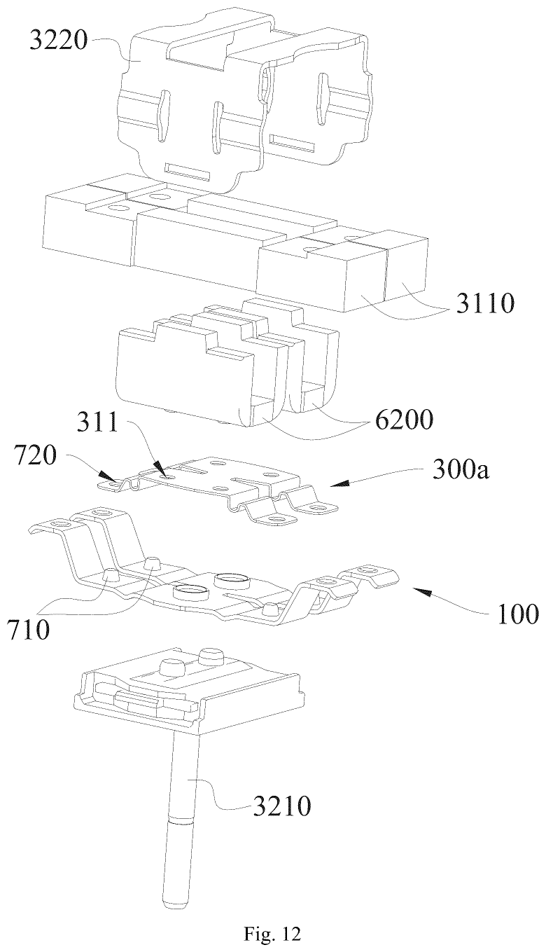

As shown in FIG. 11 and FIG. 12, the relay of the second embodiment has substantially the same basic structure as the relay of the first embodiment. Therefore, in the following description of the relay of the second embodiment, the structure already described in the first embodiment is not repeated. In addition, the same reference symbols are given to the same structures as the relay described in the first embodiment. Therefore, in the following description of this embodiment, the differences from the relay of the first embodiment are mainly described.

In the second embodiment, the second elastic piece 300a includes a second base portion 310, a deformation portion 320 and a connection portion 330. The second base portion 310 is connected to the movable contact assembly 3100 through the second anti-rotation structure 400. The deformation portion 320 and the connection portion 330 are provided on both sides of the second base portion 310 along the first direction D1. The second base portion 310 is connected to the connection portion 330 through the deformation portion 320, and the connection portion 330 is connected to the first base portion 110 of the first elastic piece 100 through the third anti-rotation structure 700.

In the embodiment of the present disclosure, the second base portion 310 is connected to the second magnetizer 6200 through the second anti-rotation structure 400. The second limiting holes 311 of the second anti-rotation structure 400 are provided on the second base portion 310, and the second limiting protrusions 410 are provided on the second magnetizer 6200. The third limiting holes 720 of the third anti-rotation structure 700 are provided on the connection portion 330, and the third limiting protrusions 710 are provided on the first base portion 110.

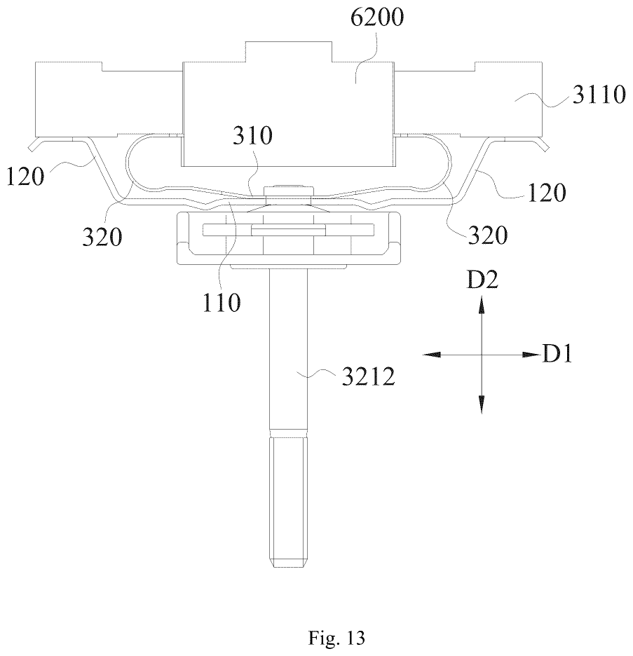

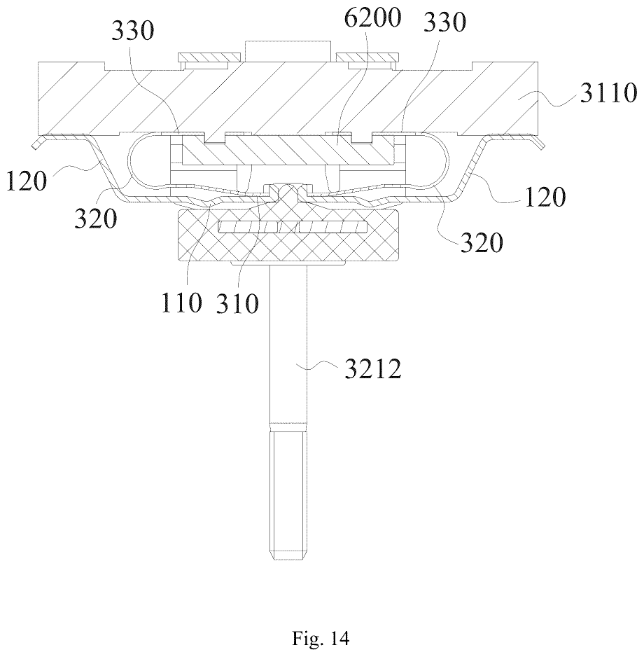

As shown in FIG. 13 and FIG. 14, the relay of the third embodiment has substantially the same basic structure as the relay of the first embodiment. Therefore, in the following description of the relay of the third embodiment, the structure already described in the first embodiment is not repeated. In addition, the same reference symbols are given to the same structures as the relay described in the first embodiment. Therefore, in the following description of this embodiment, the differences from the relay of the first embodiment are mainly described.

In the third embodiment, the second base portion 310 of the second elastic piece 300a is connected to the first base portion 110 of the first elastic piece 100 through the second anti-rotation structure 400. The connection portions 330 on both sides of the second base portion 310 are respectively inserted between the second magnetizer 6200 and the movable contact piece 3110 from both sides of the first direction D1, and are fixedly connected to the movable contact piece 3110 and the second magnetizer 6200.

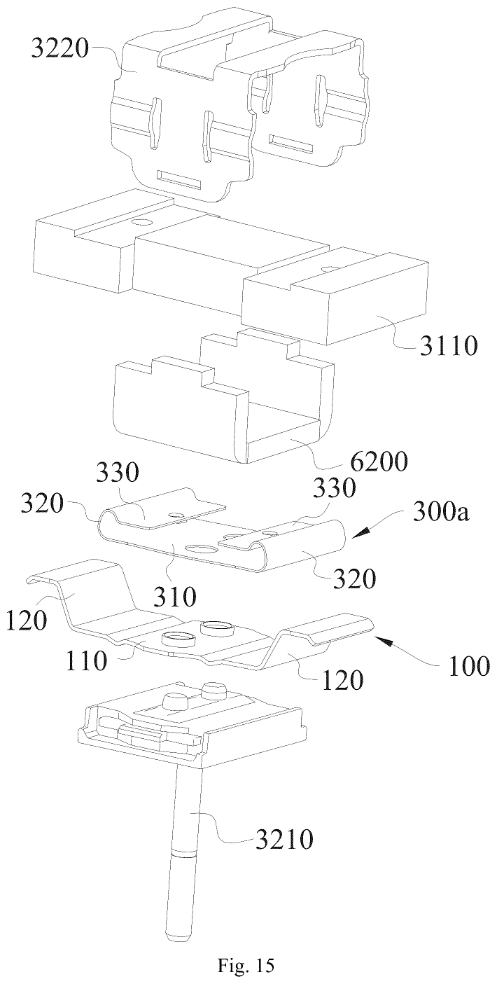

As shown in FIG. 15, the relay of the fourth embodiment has substantially the same basic structure as the relay of the first embodiment. Therefore, in the following description of the relay of the fourth embodiment, the structure already described in the first embodiment is not repeated. In addition, the same reference symbols are given to the same structures as the relay described in the first embodiment. Therefore, in the following description of this embodiment, the differences from the relay of the first embodiment are mainly described.

In the fourth embodiment, the movable contact assembly 3100 includes one movable contact piece 3110 and one second magnetizer 6200. One elastic arm 120 is provided on both sides of the first base portion 110, and one deformation portion 320 and one connection portion 330 are provided on both sides of the second base portion 310.

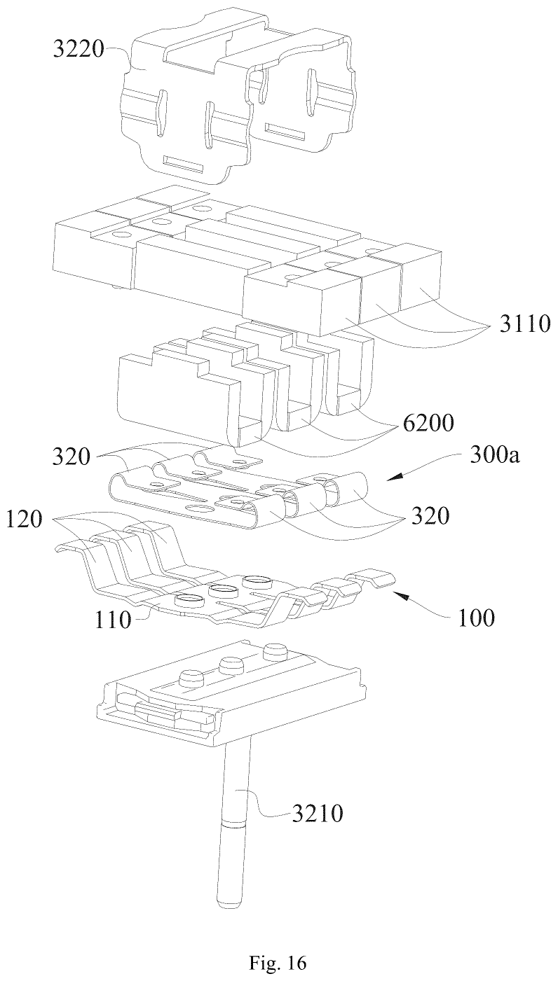

As shown in FIG. 16, the relay of the fifth embodiment has substantially the same basic structure as the relay of the first embodiment. Therefore, in the following description of the relay of the fifth embodiment, the structure already described in the first embodiment is not repeated. In addition, the same reference symbols are given to the same structures as the relay described in the first embodiment. Therefore, in the following description of this embodiment, the differences from the relay of the first embodiment are mainly described.

In the fifth embodiment, the movable contact assembly 3100 includes three movable contact pieces 3110 and three second magnetizers 6200 arranged side by side. Three elastic arms 120 are provided on both sides of the first base portion 110, and three deformation portions 320 and three connection portions 330 are provided on both sides of the second base portion 310. The three elastic arms 120 located on one side of the first base portion 110 respectively abut against ends of the three movable contact pieces 3110, and the three elastic arms 120 located on the other side of the first base portion 110 respectively abut against the other ends of the three movable contact pieces 3110. Six connection portions 330 on both sides of the second base portion 310 are divided into three pairs, and the two connection portions 330 of each pair are arranged opposite to each other in the first direction D1, and the three pairs of the connection portions 330 are respectively connected to the three second magnetizers 6200 in a one-to-one correspondence.

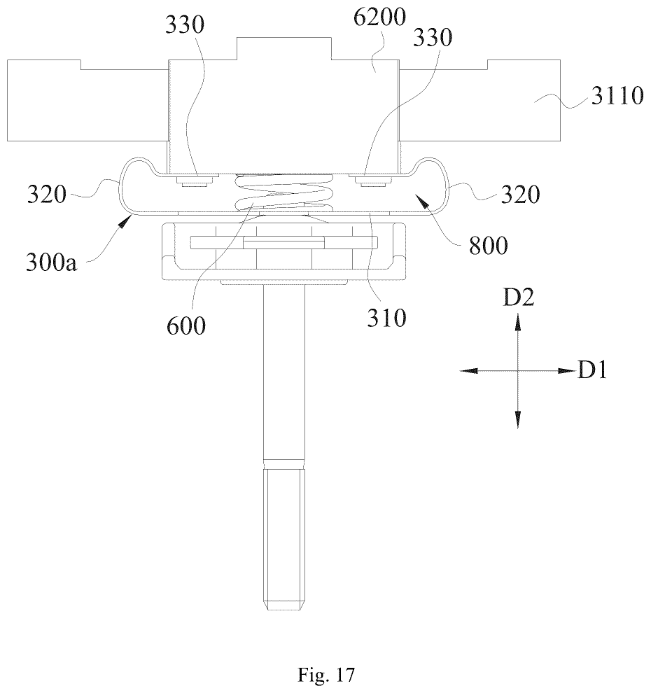

As shown in FIG. 17, the relay of the sixth embodiment has substantially the same basic structure as the relay of the first embodiment. Therefore, in the following description of the relay of the sixth embodiment, the structure already described in the first embodiment is not repeated. In addition, the same reference symbols are given to the same structures as the relay described in the first embodiment. Therefore, in the following description of this embodiment, the differences from the relay of the first embodiment are mainly described.

In the sixth embodiment, the elastic assembly 3230 is a compression spring 600, the compression spring 600 is disposed in the chamber 800 surrounded by the second elastic piece 300a and the second magnetizer 6200, and one end of the compression spring 600 abuts against the second magnetizer 6200, and the other end of the compression spring 600 abuts against the second base portion 310 of the second elastic piece 300a. The compression spring 600 is used to provide contact pressure.

Of course, in other embodiments, the second base portion 310 of the second elastic piece 300a can also be connected to the second magnetizer 6200 of the movable contact assembly 3100, and the connection portion 330 of the second elastic piece 300a is connected to the push rod assembly 3200. The compression spring 600 is disposed in the chamber surrounded by the second elastic piece 300a and the push rod assembly 3200. One end of the compression spring 600 abuts against the push rod assembly 3200, and the other end of the compression spring 600 abuts against the second base portion 310 of the second elastic piece 300a.

It should be noted that the relay in the first to sixth embodiments above, wherein the anti-short circuit structure can also be a follow-up type, that is, the first magnetizer 6100 is fixedly connected to the top wall 3221 of the contact bracket 3220.

In addition, the limiting component 300 is not limited to the second elastic piece 300a having an elastic piece structure. For example, the limiting component 300 may further include a telescopic rod, one end of the telescopic rod is connected to the movable contact assembly 3100, and the other end of the telescopic rod is connected to the first elastic piece 100 or the push rod 3210, and the telescopic rod can be extended and retracted along the second direction D2. In another embodiment, the limiting component 300 may further include at least two compression springs, one end of each compression spring is limitedly connected or fixedly connected to the first elastic piece 100, and the other end of each compression spring is limitedly connected or fixedly connected to the movable contact assembly 3100.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected embodiment” can be directly connected, or indirectly connected through an intermediary medium. For the ordinary skilled person in the art, the specific meanings of these terms in the invention can be understood based on the specific circumstances.

In the description of the embodiments of the present disclosure, the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the invention.

In the description of this specification, terms such as “an embodiment,” “some embodiments,” “a specific embodiment” refer to the specific features, structures, materials, or characteristics described in conjunction with the embodiment or example being included in at least one embodiment or example of the invention. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

What is claimed is:

1. A relay, comprising:
a movable contact assembly comprising a movable contact piece;
a push rod assembly configured to push the movable contact assembly to move, to make the movable contact piece contact with or separate from a static contact leading-out terminal;
a limiting component connected to the movable contact assembly and the push rod assembly, and configured to restrict the movable contact assembly from rotating around an axis of the push rod assembly relative to the push rod assembly; and
an elastic assembly configured to provide a contact pressure.

2. The relay according to claim 1, wherein the limiting component can be deformed to adapt to over-travel.

3. The relay according to claim 1, wherein the elastic assembly is a first elastic piece; the first elastic piece connected to one of the push rod assembly and the movable contact assembly, and abuts against another one of the push rod assembly and the movable contact assembly.

4. The relay according to claim 3, wherein the first elastic piece and the movable contact assembly together form an accommodation chamber, the limiting component is disposed in the accommodation chamber.

5. The relay according to claim 3, wherein the relay further comprises a pair of static contact leading-out terminals, both ends of the movable contact piece along a first direction are configured to contact with or separate from the pair of static contact leading-out terminals respectively; wherein the first direction is an arrangement direction of the pair of static contact leading-out terminals;
the first elastic piece comprises a first base portion and elastic arms, the first base portion is connected to the push rod assembly through a first anti-rotation structure, both ends of the first base portion along the first direction are provided at least one of the elastic arms;
the elastic arms at both ends of the first base portion along the first direction are respectively abuts against both ends of the movable contact piece along the first direction.

6. The relay according to claim 5, wherein the elastic arm comprises an extension portion and an abutting portion, the extension portion is connected to the first base portion, the abutting portion is connected to one end of the extension portion far away from the first base portion, and abuts against one end of the movable contact piece along the first direction; wherein a width of an end of the extension portion connected to the first base portion is greater than a width of an end of the extension portion connected to the abutting portion.

7. The relay according to claim 6, wherein the width of the extension portion gradually decreases from the first base portion to the abutting portion.

8. The relay according to claim 5, wherein the first anti-rotation structure comprises:
at least two first limiting protrusions disposed on one of the push rod assembly and the first base portion; and
at least two first limiting holes disposed on another one of the push rod assembly and the first base portion; wherein the at least two first limiting protrusions are inserted into the at least two first limiting holes respectively.

9. The relay according to claim 1, wherein the limiting component is a second elastic piece, the second elastic piece is connected to one of the elastic assembly and the movable contact assembly through a second anti-rotation structure, and connected to another one of the elastic assembly and the movable contact assembly through a third anti-rotation structure.

10. The relay according to claim 9, wherein the second anti-rotation structure comprises:
at least two second limiting protrusions disposed on one of the elastic assembly and the second elastic piece;
at least two second limiting holes disposed on another one of the elastic assembly and the second elastic piece; wherein the at least two second limiting protrusions are inserted into the at least two second limiting holes respectively.

11. The relay according to claim 10, wherein the elastic assembly is connected to the push rod assembly through a first anti-rotation structure; the first anti-rotation structure comprises at least two first limiting protrusions and at least two first limiting hole, the at least two first limiting protrusions are disposed on the push rod assembly, the at least two first limiting hole are disposed on the elastic assembly, the at least two first limiting protrusions are inserted into the at least two first limiting holes respectively;
each of the second limiting protrusions is a protruding ring, one protruding ring surrounds one first limiting hole; an inner ring surface of the protruding ring is flush with a hole wall of the first limiting hole.

12. The relay according to claim 11, wherein the protruding ring is formed by turning and bending a hole edge of the first limiting hole of the elastic assembly towards a direction close to the movable contact assembly.

13. The relay according to claim 9, wherein the relay further comprises a pair of static contact leading-out terminals, both ends of the movable contact piece along the first direction are configured to contact with or separate from the pair of static contact leading-out terminals; wherein the first direction is an arrangement direction of the pair of static contact leading-out terminals;
the second elastic piece comprises a second base portion, a deformation portion and a connection portion;
the second base portion is connected to one of the elastic assembly and the movable contact assembly through a second anti-rotation structure, both sides of the second base portion along the first direction are provided with the deformation portion and the connection portion, the second base portion is connected to the connection portion through the deformation portion; the connection portion is connected to another one of the elastic assembly and the movable contact assembly through a third anti-rotation structure.

14. The relay according to claim 13, wherein along the first direction, the connection portion located at one side of the second base portion and the movable contact assembly form a first joint, the connection portion located at another side of the second base portion and the movable contact assembly form a second joint,
there is a first distance between the first joint and the second joint, there is a second distance between the deformation ports at both sides of the second base port, and the first distance is smaller than the second distance; wherein the second distance is a maximum distance between the deformation portions at both sides of the second base portion.

15. The relay according to claim 9, wherein the third anti-rotation structure comprises:
at least two third limiting protrusions disposed on one of the second elastic piece and the movable contact assembly; and
at least two third limiting holes disposed on another one of the second elastic piece and the movable contact assembly; the at least two third limiting protrusions are inserted into the at least two third limiting holes.

16. The relay according to claim 1, wherein the relay further comprises a first magnetizer;
the first magnetizer is disposed at a side of the movable contact assembly facing the static contact leading-out terminal, and configured to resist an electric repulsion force.

17. The relay according to claim 16, wherein the movable contact assembly further comprises a second magnetizer, the second magnetizer is fixedly connected to a side of the movable contact piece facing away from the static contact leading-out terminal; the second magnetizer is configured to form a magnetic circuit with the first magnetizer.

18. The relay according to claim 17, wherein the relay further comprises a pair of static contact leading-out terminals, both ends of the movable contact piece along a first direction are configured to contact with or separate from the pair of static contact leading-out terminals; wherein the first direction is an arrangement direction of the pair of static contact leading-out terminals;
the limiting component is a second elastic piece, the second elastic piece comprises a second base portion, a deformation portion and a connection portion;
both sides of the second base portion along the first direction are provided with the deformation portion and the connection portion, the second base portion is connected to the connection portion through the deformation portion; the second base portion is connected to the elastic assembly;
the connection portions at both sides of the second base portion are respectively inserted between the second magnetizer and the movable contact piece from two sides of the second magnetizer along the first direction, and fixedly connected to the movable contact piece and the second magnetizer.

19. The relay according to claim 1, wherein the elastic assembly is a first elastic piece, the limiting component is a second elastic piece, a thickness of the second elastic piece is smaller than a thickness of the first elastic piece.

20. The relay according to claim 1, wherein the elastic assembly is a compression spring, the compression spring is configured to provide contact pressure.

21. The relay according to claim 20, wherein one end of the compression spring abuts against the limiting component, another end of the compression spring abuts against the movable contact assembly or the push rod assembly.

22. The relay according to claim 21, wherein the limiting component is a second elastic piece;
the second elastic piece comprises a second base portion, a deformation portion and a connection portion; the second base portion is connected to the push rod assembly, both sides of the second base portion along the first direction are provided with the deformation portion and the connection portion, the second base portion is connected to the connection portion through the deformation portion; the connection portion is connected to the movable contact assembly; wherein the first direction is an arrangement direction of the pair of static contact leading-out terminals;
the second elastic piece and the movable contact assembly surround and form a chamber, the compression spring is disposed in the chamber, and one end of the compression spring abuts against the second base portion, and another end of the compression spring abuts against the movable contact assembly.

23. The relay according to claim 1, wherein the relay further comprises a pair of static contact leading-out terminals, both ends of the movable contact piece along a first direction are configured to contact with or separate from the pair of static contact leading-out terminals; wherein the first direction is an arrangement direction of the pair of static contact leading-out terminals;
the elastic assembly and the push rod assembly are connected in a limited way along the first direction; and/or, the limiting component and the movable contact assembly are connected in a limited way along the first direction; and/or, the limiting component and the elastic assembly are connected in a limited way along the first direction.

24. The relay according to claim 1, wherein the push rod assembly comprises a contact bracket, the movable contact assembly comprises one or more movable contact pieces, the movable contact assembly is installed in the contact bracket through the elastic assembly.
